(19) United States
(12) Patent Application Publication
(10) Pub. No.: US 2026/0145567 A1
(43) Pub. Date: May 28, 2026

(54) BATTERY, A METHOD FOR CONTROLLING CHARGING OF A BATTERY, AND A VEHICLE COMPRISING THE SAME

(71) Applicants: HYUNDAI MOTOR COMPANY, Seoul (KR); KIA CORPORATION, Seoul (KR)

(72) Inventor: Jung Hyun Lee, Hwaseong-si (KR)

(73) Assignees: HYUNDAI MOTOR COMPANY, Seoul (KR); KIA CORPORATION, Seoul (KR)

(21) Appl. No.: 19/236,049

(22) Filed: Jun. 12, 2025

(30) Foreign Application Priority Data
Nov. 28, 2024 (KR) 10-2024-0173825

(51) Int. Cl. B60L 53/62; B60L 53/10; B60L 58/13; B60L 58/18; H02J 7/00

(52) U.S. Cl. CPC B60L 53/62; B60L 53/11; B60L 58/13; B60L 58/18; H02J 7/50; H02J 7/82; H02J 7/96; B60L 2210/12; B60L 2240/547

(57) ABSTRACT

A vehicle includes a first battery including a plurality of first battery cells, a second battery including a plurality of second battery cells, and a switch box. The switch box is configured to selectively switch an electrical connection between the first battery and the second battery and selectively switch a connection of charging power to the first battery or the second battery. The vehicle further includes a battery controller configured to monitor states of the first battery and the second battery and control the switch box. The vehicle further includes a charging controller configured to determine a charging mode for the first battery or the second battery according to a charging voltage and transmit a command according to the charging mode to the battery controller.

### CROSS-REFERENCE TO RELATED APPLICATIONS

This application claims the benefit of and priority to Korean Patent Application No. 10-2024-0173825, filed on Nov. 28, 2024, the entire contents of which are hereby incorporated herein by reference.

### TECHNICAL FIELD

The present disclosure relates to a battery, a method for controlling the charging thereof, and a vehicle using the same.

### BACKGROUND

An external charger used for charging an electric vehicle may be largely divided into a high-speed (or rapid) charger and a slow charger.

The high-speed charger uses a high-voltage charging power, and the slow charger uses a relatively low voltage.

When the voltage of a vehicle battery is greater than that of the slow charger, a booster needs to be separately provided in the vehicle in order to perform charging by the slow charger, which may be a factor of increasing the cost of the vehicle.

The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

An embodiment of the present disclosure provides a battery which can be charged even by a slow charger as well as a rapid charger and also provides a vehicle including the same and a method for controlling the charging.

Another aspect of the present disclosure provides a battery capable of being charged by an external charger of a low voltage without a booster and provides a vehicle including the same and a method for controlling the charging.

According to an embodiment of the present disclosure, a vehicle includes a first battery including a plurality of first battery cells, a second battery including a plurality of second battery cells, and a switch box. The switch box is configured to selectively switch an electrical connection between the first battery and the second battery and selectively switch a connection of charging power to the first battery or the second battery. The vehicle further includes a battery controller configured to monitor states of the first battery and the second battery and control the switch box. The vehicle further includes a charging controller configured to determine a charging mode for the first battery or the second battery according to a charging voltage and transmit a command according to the charging mode to the battery controller.

In one embodiment of the present disclosure, the switch box includes a relay assembly electrically connected to a positive terminal of the first battery and electrically connected to a negative terminal of the second battery. The switch box further includes a first switch configured to switch a series connection between the first battery and the second battery. The switch box further includes a second switch configured to switch an electrical connection between the negative terminal of the first battery and the relay assembly. The switch box further includes a third switch configured to switch an electrical connection between the positive terminal of the second battery and the relay assembly.

In an embodiment of the present disclosure, the charging mode includes a separate charging mode in which the first battery and the second battery are separately charged. The charging mode further includes a connection charging mode in which the first battery and the second battery are connected and charged.

In an embodiment of the present disclosure, the switch box is configured to disconnect the electrical connection between the first battery and the second battery and selectively connect the charging power to the first battery or the second battery in the separate charging mode.

In at least one embodiment of the present disclosure, the switch box is configured to sequentially connect the charging power to the first battery and the second battery, or to the second battery and the first battery, in a state in which the electrical connection between the first battery and the second battery is disconnected in the separate charging mode.

In at least one embodiment of the present disclosure, in a state in which the electrical connection between the first battery and the second battery is disconnected in the separate charging mode, the switch box is configured to perform a first connection of connecting the charging power to the first battery for a first charging, a second connection of connecting the charging power to the second battery for a second charging after the first charging, a third connection of connecting the charging power to the first battery for a third charging after the second charging, and a fourth connection of connecting the charging power to the second battery for a fourth charging after the third charging.

In an embodiment of the present disclosure, the charging controller is configured to perform the first charging and the second charging by a rapid charging and perform the third charging and the fourth charging by a slow charging.

In an embodiment of the present disclosure, the switch box is configured to perform a fifth connection of connecting the charging power to the first battery for multiple times and a connection of connecting the charging power to the second battery for multiple times, in the separate charging mode.

In an embodiment of the present disclosure, the switch box is configured to connect the first battery and the second battery in series in the connection charging mode.

In an embodiment of the present disclosure, the charging controller is configured to determine a separate charging mode when the charging voltage is higher than a series connection voltage of the first battery and the second battery and determine a connection charging mode when the charging voltage is higher than the series connection voltage.

According to an embodiment of the present disclosure, a battery comprises a first battery including a plurality of first battery cells, a second battery including a plurality of second battery cells, and a switch box. The switch box is configured to selectively switch an electrical connection between the first battery and the second battery and selectively switch a connection of charging power to the first battery or the second battery. The battery further includes a battery controller configured to monitor states of the first battery and the second battery, transmit information of the states to a charging controller of a vehicle, and control the switch box according to a command received from the charging controller.

In the battery according to an embodiment of the present disclosure, the switch box includes a relay assembly electrically connected to a positive terminal of the first battery and electrically connected to a negative terminal of the second battery. The switch box further includes a first switch configured to switch a series connection between the first battery and the second battery. The switch box further includes a second switch configured to switch an electrical connection between the negative terminal of the first battery and the relay assembly. The switch box further includes a third switch configured to switch an electrical connection between the positive terminal of the second battery and the relay assembly.

According to an embodiment of the present disclosure, the command includes a first command for a separate charging mode and a second command for a connection charging mode. The switch box is configured to disconnect the electrical connection between the first battery and the second battery and selectively connect the charging power to either the first battery or the second battery in the separate charging mode.

According to one embodiment of the present disclosure, the switch box is configured to sequentially connect the charging power to the first battery and the second battery, or to the second battery and the first battery, in a state in which the electrical connection between the first battery and the second battery is disconnected in the separate charging mode.

According to one embodiment of the present disclosure in a state in which the electrical connection between the first battery and the second battery is disconnected in the separate charging mode, the switch box is configured to perform a first connection of connecting the charging power to the first battery for a first charging, a second connection of connecting the charging power to the second battery for a second charging after the first charging, a third connection of connecting the charging power to the first battery for a third charging after the second charging, and a fourth connection of connecting the charging power to the second battery for a fourth charging after the third charging.

According to one embodiment of the present disclosure, the switch box is configured to connect the charging power to the first battery for multiple times and connect the charging power to the second battery for multiple times in the separate charging mode.

According to one embodiment of the present disclosure, the switch box is configured to connect the first battery and the second battery in series in the connection charging mode.

In accordance with another aspect of the present disclosure, a method for controlling the charging vehicle battery includes determining, by a vehicle controller, a charging mode based on a comparison between a charging voltage of an external charger and a battery voltage. The method further includes transmitting, by the vehicle controller, a command of the charging mode to a battery controller. The method further includes selectively switching, by a switch box, an electrical connection between a first battery and a second battery and selectively switching, by the switch box, a connection of charging power to the first battery or the second battery, according to a control of the battery controller based on the command of the charging mode. The method further includes supplying, by the vehicle controller, the charging power to the switch box according to the charging mode by controlling a charging circuit.

According to one embodiment of the present disclosure, the charging mode includes a separate charging mode for separately charging the first battery and the second battery and a connection charging mode for connecting and charging the first battery and the second battery.

According to one embodiment of the present disclosure, selectively switching includes releasing a series connection between the first battery and the second battery through a first switch and selectively connecting the charging power to the first battery or the second battery through a second switch and a third switch, in the separate charging mode.

According to one embodiment of the present disclosure, the battery can be charged by a slow charger as well as a rapid charger.

In addition, according to an embodiment of the present disclosure, charging by an external charger with low voltage is possible without a booster.

### BRIEF DESCRIPTION OF THE DRAWINGS

FIG. 1 shows a vehicle according to an embodiment of the present disclosure.

FIG. 2A, FIG. 2B, FIG. 2C, and FIG. 2D illustrate a method of controlling charging according to an embodiment of the present disclosure.

### DETAILED DESCRIPTION

Because the present disclosure may be modified in various ways and have various forms, specific embodiments are illustrated and described in the drawings. However, the present disclosure is not intended to be limited to specific embodiments, and it should be understood that the present disclosure covers all the modifications, equivalents, and alternatives included within the idea and technical scope of the present disclosure.

The suffixes “module” and “unit” used in the present specification are only used for name division between components and should not be construed as being physiochemically divided or separated, or assuming that they may be divided or separated. When a controller, module, unit, component, device, element, or the like of the present disclosure is described as having a purpose or performing an operation, function, or the like, the controller, module, unit, component, device, element, or the like should be considered herein as being “configured to” meet that purpose or to perform that operation or function. Each controller, module, unit, component, device, element, and the like may separately embody or be included with a processor and a memory, such as a non-transitory computer readable media, as part of the apparatus.

Terms including ordinals such as “first”, “second”, etc. may be used to describe various elements, but the elements are not limited by the terms. The terms may be used only as a name meaning for distinguishing one element from another element, and an order meaning between them should be recognized through the context of the corresponding description.

The term “and/or” is used to include all possible combinations of the listed items. For example, “A and/or B” includes all three cases such of “A”, “B”, “A and B”.

It should be understood that when an element is referred to as being “connected” or “coupled” to another element, it may be directly connected to the other element, or intervening elements may also be present.

The terms used herein are for the purpose of describing particular embodiments only and are not intended to limit the present disclosure. Singular expressions include plural expressions unless the context clearly indicates otherwise. In the present disclosure, it should be understood that terms, such as “include” or “have,” are intended to designate the existence of the features, numbers, steps, operations, components, parts, or combinations thereof described in the present disclosure and are not intended to preclude the possibility that one or more other features, numbers, steps, operations, components, parts, or combinations thereof may exist or may be added.

Unless terms are defined differently, all terms used herein, including technical or scientific terms, have the same meanings as those generally understood by those having ordinary skill in the art to which the present disclosure pertains. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

In addition, the terms, such as a unit, a control unit, a control device, and a controller, are widely used to name devices that control specific functions and do not refer to a generic functional unit. Also, the device denoted by the names may include a communication device that communicates with another controller or sensor to control the corresponding function, a computer-readable recording medium that stores an operation system, a logic command, and input/output information, and at least one processor that performs determinations, calculations, and decisions required for function control.

On the other hand, the processor may include semiconductor integrated circuits and/or electronic elements that perform at least one or more of comparisons, determinations, operations, or decisions to achieve programmed functions. For example, the processor may be a computer, a microprocessor, a CPU, an ASIC, and an electronic circuitry (logic circuits), or a combination thereof.

In addition, the computer-readable recording medium (or, simply referred to as a memory) includes all types of storage devices that store computer readable data. For example, the memory may include at least one of a flash memory type, a hard disk type, a micro type, or a card type (e.g., a secure digital (SD) card or an eXtream digital (XD) type memory and a Random Access Memory (RAM), a Static RAM (SRAM), a Read-Only Memory (ROM), a Programmable ROM (PROM), an Electrically Erasable PROM (EEPROM), a Magnetic RAM (MRAM), a magnetic disk, and an optical disk type memory).

These recording media may be electrically connected to the processor, and the processor may read data from and write data to the recording media. The recording media and the processor may be integrated with each other or physically separated from each other.

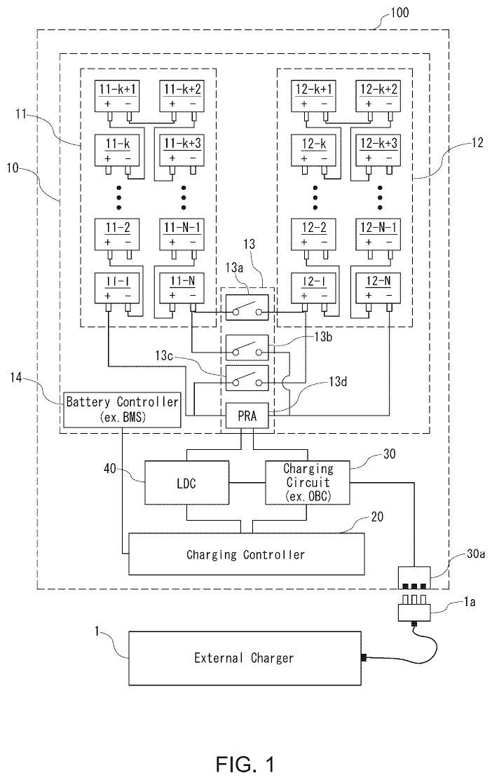

Referring to FIG. 1, a vehicle 100 according to an embodiment of the present disclosure includes a (high voltage) battery 10, a buck DC-DC converter (hereinafter, referred to as a low voltage converter 40), a charging circuit such as an on-board charger (OBC), and a charging controller 20.

The battery 10 includes a first battery 11 and a second battery 12.

The first battery 11 may include a plurality of first battery cells 11-1 to 11-N that output a voltage of e.g., 2.7 to 4.2 V, and the first battery cells 11-1 to 11-N are connected in series/parallel to form one module and output a first output voltage.

In addition, the second battery 12 may include a plurality of second battery cells 12-1 to 12-N that output a voltage of e.g. 2.7 to 4.2 V, and the second battery cells 12-1 to 12-N are connected to each other in series/parallel to form one module and output a second output voltage.

Although the first output voltage and the second output voltage may be different, in the present embodiment, the first output voltage and the second output voltage may be both approximately 400 V. The battery 10 of the present embodiment may be a high-voltage battery of 800 V when the first battery 11 and the second battery 12 are connected in series under the control of a switch box 13 described below. The battery 10 may also serve as a low-voltage battery of 400 V when the serial connection is released.

The battery 10 includes a battery controller 14, and the battery controller 14 may include a battery management system (BMS).

The BMS may include a battery management unit (BMU) and a cell monitoring unit (CMU).

The BMS performs a cell balancing function for ensuring performance of the entire battery pack by maintaining a constant voltage of each battery cell, a state of charge (SoC) function for calculating a capacity of the entire battery system, battery cooling, charging, discharging control, etc.

The BMU receives information of all battery cells from the CMU and performs the functions of the BMS based on the received information.

The BMU may include two micro control units (MCUs), and each MCU has one controller area network (CAN) communication port. A CAN interface may be included to communicate with the vehicle controller, which may be an upper-level device of the BMS, and a CAN interface may be included to collect information of the CMU, which is a lower-level device.

The CMU may be directly attached to the battery cells to sense voltage, current, temperature, etc. The CMU does not perform an operation related to the BMS algorithm and may simply be in charge of sensing. A plurality of battery cells may be connected to one CMU, and information of each cell is transmitted to the BMU through a CAN interface.

In addition, the battery controller 14 may be communicatively connected to the charging controller 20 and may control the switch box 13 in accordance with a transmitted command therefrom.

In the present embodiment, the battery controller 14 is illustrated as one integrated controller, but it is not necessarily limited thereto, and the battery controller 14 may include a first battery controller for the first battery 11 and a second battery controller for the second battery 12.

The switch box 13 may include a first switch 13a, a second switch 13b, a third switch 13c, and a power relay assembly (PRA) 13d.

The power relay assembly 13d serves to supply power of the battery 10 to the vehicle driving motor or cut off the supply of power. In addition, in order to prevent damage to the inverter due to a high voltage inrush current, the power relay assembly 13d may include a pre-charge relay for an initial charging and a rapid charging relay for performing rapid charging with a DC voltage.

The battery 10 may be electrically connected to an external device, such as an on-board charger 30, an inverter of a driving motor, a low voltage converter 40, or the like through a positive terminal and a negative terminal of the power relay assembly 13d.

A positive terminal of the first battery 11 is connected to a positive terminal of the power relay assembly 13d, and a negative terminal of the second battery 12 is connected to a negative terminal of the power relay assembly 13d. Also, the negative terminal of the first battery 11 is connected to the first switch 13a and the second switch 13b, and the positive terminal of the second battery 12 is connected to the first switch 13a and the third switch 13c.

The second switch 13b is also connected to the negative terminal of the power relay assembly 13d, and the third switch 13c is connected to the positive terminal of the power relay assembly 13d.

Therefore, with the first switch 13a maintained in the closed state and the second switch 13b and the third switch 13c in the open state, the first battery 11 and the second battery 12 are connected in series, and the battery 10 may output the sum power of the first output voltage and the second output voltage.

In addition, with the second switch 13b maintained in the closed state and the first switch 13a and the third switch 13c in the open state, the battery 10 is switched to a state where a power may be a sole output from the first battery 11.

In addition, with the third switch 13c maintained in the closed state and the first switch 13a and the second switch 13b in the open state, the battery 10 is switched to a state where the power may be a sole output from the second battery 12.

The low voltage converter 40 may be configured to buck down the power of the battery 10 and supply the power to the charging controller 20 as well as an electronic device in the vehicle 100 to serve as a power supply source and may also charge a low-voltage battery.

For example, the low voltage converter 40 may buck down the voltage of 800 V of the battery 10 to 12 V.

When the charging connector 1a of the external charger 1 is connected to the charging socket 30a of the vehicle 100, the charging controller 20 receives relevant information from the external charger 1 and controls or transmits a control command to the on-board charger 30, the low-voltage battery, the battery controller 14, or the like.

The charging controller 20 may be a charge-only controller, or may be a upper-level vehicle controller.

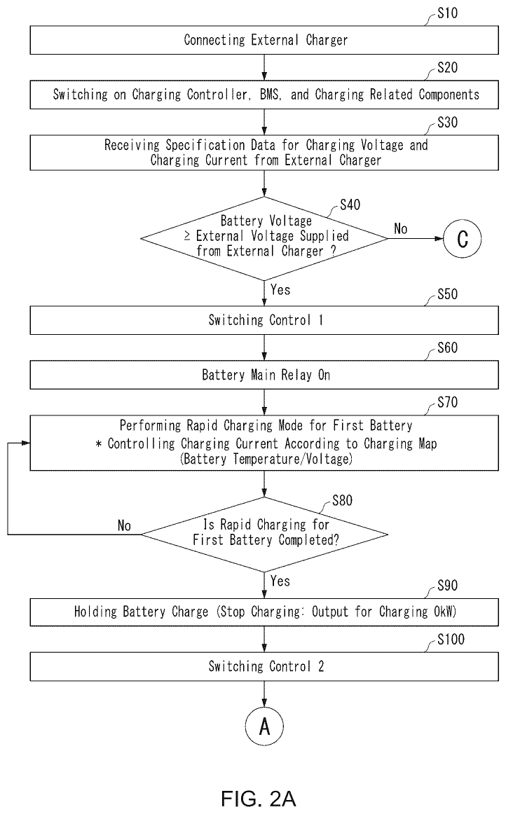

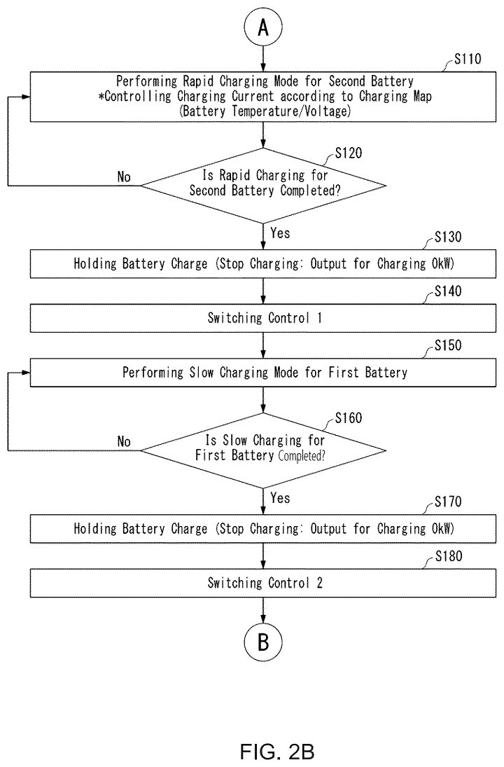

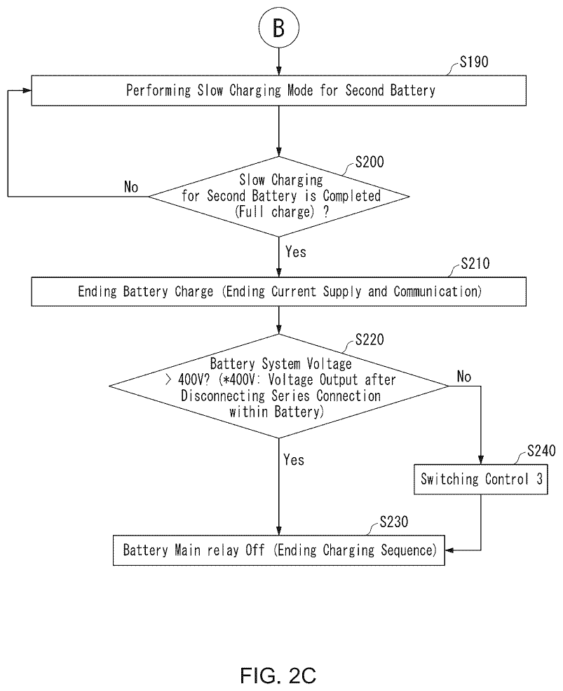

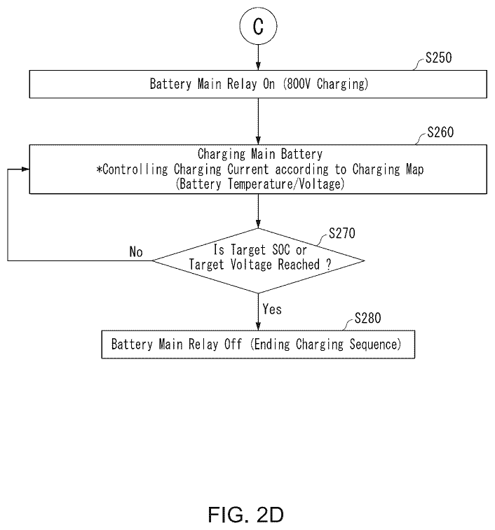

FIG. 2A, FIG. 2B, FIG. 2C, and FIG. 2D illustrate a method for controlling the charging according to an embodiment of the present disclosure, and this is described in detail below.

When the charging connector 1a of the external charger 1 is connected to the charging socket 30a of the vehicle 100 in operation S10 of FIG. 2A, the charging controller 20 is switched on and activated in operation S20 and performs the method for controlling the charging of the present embodiment.

In S20, the charging controller 20 with its related components, e.g., the battery controller 14, the onboard charger 30, and charging related components, such as the low voltage converter 40, are switched on.

In the following operation S30, the charging controller 20 receives charging related data, such as a charging voltage and a charging current, from the external charger 1. The data communication thereof may be by a communication line connection between the charging connector 1a and the charging socket 30a, without being limited thereto. Wireless communication may be used for the data communication.

In S40, the charging controller 20 compares the voltage of the battery 10 with the charging voltage.

The charging controller 20 may determine a charging mode according to the comparison result, and the charging mode may include a separate charging mode and a connection charging mode.

In the connection charging mode, the first battery 11 and the second battery 12 are connected in series to charge the entire battery 10, which is described below with reference to FIG. 2D. The separate charging mode is described with reference to FIGS. 2A, 2B, and 2C.

When it is determined that the voltage (e.g., 760 V) of the battery 10 is greater than or equal to the charging voltage (e.g., 200 to 500 V) (Yes in S40), the charge controller 20 determines the charging mode as the separate charge mode and proceeds to S50.

The charging controller 20 may transmit a command for the separate charging mode to the battery controller 14, and the battery controller 14 controls the switch box 13 accordingly.

The battery controller 14 performs the first switching control in S50.

In the first switching control, the first switch 13a and the third switch 13c are maintained open, and the second switch 13b is maintained closed.

In the state in which the first switching control is maintained, the battery controller 14 controls the switch box 13 to switch the main relay of the power relay assembly 13d on in S60.

Accordingly, the battery 10 is in a state in which the charging power may be supplied only to the first battery 11. In the present embodiment, because the voltage of the first battery 11 is only about half of the total voltage of the battery 10, it may be a voltage lower than the charging voltage, and thus, the separate charging by the charging voltage may be possible, even if there is no boost converter.

When the first battery 11 becomes chargeable, the charging controller 20 performs rapid charging (before the first charging) on the first battery 11 while controlling the charging current through the on-board charger 30 according to a first charging map set for the temperature and voltage of the battery 10 in S70. In this case, the state information such as the temperature of the battery 10 may be received by the charging controller 20 through the battery controller 14.

Here, the rapid charging may be performed by a stepped constant current charging process or may be performed until a target charging current or a charging power is reached. The charging controller 20 determines whether the rapid charging process of the first battery 11 is completed in S80 and proceeds to S90 when the rapid charging process of the first battery 11 is completed (Yes in S80).

In S90, the charging controller 20 may control the on-board charger 30 to buck the charging power to 0 (zero) and stop the charging.

Next, the charging controller 20 may transmit a rapid-charging command for the second battery 12 to the battery controller 14, and accordingly, the battery controller 14 controls the switch box 13 to perform the second switching control in S100.

In the second switching control, the first switch 13a and the second switch 13b are maintained open, and the third switch 13c is switched to the closed state. In this state, the first battery 11 is electrically disconnected from the on-board charger 30, and only the second battery 12 is electrically connected to the on-board charger 30.

The charging controller 20 may be notified of the completion of the charge ready state of the second battery 12 from the battery controller 14, and accordingly in S110, the on-board charger 30 is controlled according to the second charging map for the temperature and voltage of the battery 10 to perform the rapid charging (second charging) for the second battery 12 while controlling the charging current.

The charging controller 20 performs the second charging through the set charging process as in the first charging and determines whether the rapid charging of the second battery 12 is completed in S120.

When the second charging is completed (Yes in S120), the charging controller 20 may control the on-board charger 30 to buck the charging power to 0 (zero) and may stop the charging in S130.

Next, the charging controller 20 may perform the first switching control again in S140.

In addition, the charging controller 20 may perform slow charging (third charging) of the first battery 11 in S150.

For the slow charging, the charging controller 20 may control the on-board charger 30 so that the charging is performed by a constant voltage charging process or a low current continuous charging process.

The charge controller 20 may determine whether the first battery 11 is fully charged in S160 and may proceed to S170 when the full charge of the first battery 11 is completed (Yes in S160).

In S170, the charging controller 20 may control the on-board charger 30 to buck the charging power to 0 (zero) and may stop the charging.

Next, the charging controller 20 performs a second switching control in S180.

In addition, the charging controller 20 may perform slow charging (fourth charging) of the second battery 12 in S190.

Similarly, for slow charging of the second battery 12, the charging controller 20 may control the on-board charger 30 to proceed with charging with a constant voltage charging process or a low current continuous charging process.

The charge controller 20 may determine whether the second battery 12 is fully charged in S200 and may proceed to S210 when the full charge of the second battery 12 is completed (yes in S200).

In S210, the charging controller 20 controls the on-board charger 30 to buck the charging power to 0 (zero) and terminates the charging.

Thereafter, the charging controller 20 determines whether the voltage of the battery 10 is greater than or equal to a predetermined voltage (e.g., 400 V) in S 220.

In this case, when it is determined that the voltage of the battery 10 exceeds the predetermined voltage (Yes in S220), the charging controller 20 may switch the main relay of the power relay assembly 13d off in S230.

In addition, when it is determined that the voltage of the battery 10 does not exceed the predetermined voltage (No in S220), the charging controller 20 may perform the third switching control in S240 and thus may switch off the main relay of the power relay assembly 13d in S230.

In the third switching control, the first switch 13a is maintained closed, and the second switch 13b and the third switch 13c are maintained open.

Meanwhile, when it is determined that the voltage of the battery 10 is less than the charging voltage in S40 (No in S40), the charging controller 20 determines the connection charging mode as the charging mode. The connection charging process is described in detail in reference to FIG. 2D.

First, in the connection charging mode, a switching state of the switch box 13 is a third switching control state, and the battery controller 14 controls the switch box 13 to switch a main relay of the power relay assembly 13d on in S250.

In S260, the charging controller 20 performs connection charging while controlling the on-board charger 30 for the charging current according to the third charging map.

The charging controller 20 may determine whether the connection charging is completed according to whether a charging completion condition (e.g., a target state of charge (SOC) or a target voltage) set in S270 is satisfied.

When it is determined that the charging is completed (Yes in S270), the charging controller 20 may transmit a command to the battery controller 14 to switch off the main relay of the power relay assembly 13d and may end the charging in S280.

According to the present embodiment, the battery can be charged even using a charging infrastructure having a relatively low charging voltage, and in particular, a low-voltage charging infrastructure may be used even without providing a boost DC-DC converter.

What is claimed is

1. A vehicle comprising:
a first battery including a plurality of first battery cells;
a second battery including a plurality of second battery cells;
a switch box configured to:
selectively switch an electrical connection between the first battery and the second battery; and
selectively switch a connection of charging power to the first battery or the second battery;
a battery controller configured to:
monitor states of the first battery and the second battery; and
control the switch box; and
a charging controller configured to:
determine a charging mode for the first battery or the second battery according to a charging voltage; and
transmit a command according to the charging mode to the battery controller.

2. The vehicle of claim 1, wherein the switch box comprises:
a relay assembly electrically connected to a positive terminal of the first battery and electrically connected to a negative terminal of the second battery;
a first switch configured to switch a series connection between the first battery and the second battery;
a second switch configured to switch an electrical connection between the negative terminal of the first battery and the relay assembly; and
a third switch configured to switch an electrical connection between the positive terminal of the second battery and the relay assembly.

3. The vehicle according to claim 1, wherein the charging mode includes:
a separate charging mode in which the first battery and the second battery are separately charged; and
a connection charging mode in which the first battery and the second battery are connected and charged.

4. The vehicle according to claim 3, wherein the switch box is configured to disconnect the electrical connection between the first battery and the second battery and selectively connect the charging power to the first battery or the second battery in the separate charging mode.

5. The vehicle of claim 4, wherein in the separate charging mode, the switch box is configured to sequentially connect the charging power to the first battery and the second battery or to the second battery and the first battery, in a state in which the electrical connection between the first battery and the second battery is disconnected.

6. The vehicle of claim 5, wherein, in a state in which the electrical connection between the first battery and the second battery is disconnected in the separate charging mode, the switch box is configured to perform a first connection of connecting the charging power to the first battery for a first charging, a second connection of connecting the charging power to the second battery for a second charging after the first charging, a third connection of connecting the charging power to the first battery for a third charging after the second charging, and a fourth connection of connecting the charging power to the second battery for a fourth charging after the third charging.

7. The vehicle according to claim 6, wherein the charging controller is configured to:
perform the first charging and the second charging by a rapid charging; and
perform the third charging and the fourth charging by a slow charging.

8. The vehicle according to claim 4, wherein the switch box is configured to perform a fifth connection of connecting the charging power to the first battery for multiple times and a sixth connection of connecting the charging power to the second battery for multiple times, in the separate charging mode.

9. The vehicle according to claim 3, wherein the switch box is configured to connect the first battery and the second battery in series in the connection charging mode.

10. The vehicle of claim 1, wherein the charging controller is configured to:
determine a separate charging mode when the charging voltage is higher than a series connection voltage of the first battery and the second battery; and
determine a connection charging mode when the charging voltage is higher than the series connection voltage.

11. A battery comprising:
a first battery including a plurality of first battery cells;
a second battery including a plurality of second battery cells;
a switch box configured to:
selectively switch an electrical connection between the first battery and the second battery; and
selectively switch a connection of charging power to the first battery or the second battery; and
a battery controller configured to:
monitor states of the first battery and the second battery;
transmit information of the states to a charging controller of a vehicle; and
control the switch box according to a command received from the charging controller.

12. The battery of claim 11, wherein the switch box comprises:
a relay assembly electrically connected to a positive terminal of the first battery and electrically connected to a negative terminal of the second battery;
a first switch configured to switch a series connection between the first battery and the second battery;
a second switch configured to switch an electrical connection between the negative terminal of the first battery and the relay assembly; and
a third switch configured to switch an electrical connection between the positive terminal of the second battery and the relay assembly.

13. The battery of claim 11, wherein the command includes a first command of a separate charging mode and a second command of a connection charging mode, and
wherein the switch box is configured to disconnect the electrical connection between the first battery and the second battery and selectively connect the charging power to either the first battery or the second battery in the separate charging mode.

14. The battery of claim 13, wherein in the separate charging mode, the switch box is configured to sequentially connect the charging power to the first battery and the second battery, or to the second battery and the first battery, in a state in which the electrical connection between the first battery and the second battery is disconnected.

15. The battery of claim 14, wherein, in a state in which the electrical connection between the first battery and the second battery is disconnected in the separate charging mode, the switch box is configured to perform a first connection of connecting the charging power to the first battery for a first charging, a second connection of connecting the charging power to the second battery for a second charging after the first charging, a third connection of connecting the charging power to the first battery for a third charging after the second charging, and a fourth connection of connecting the charging power to the second battery for a fourth charging after the third charging.

16. The battery of claim 13, wherein the switch box is configured to connect the charging power to the first battery for multiple times and connect the charging power to the second battery for multiple times, in the separate charging mode.

17. The battery of claim 13, wherein the switch box is configured to connect the first battery and the second battery in series in the connection charging mode.

18. A method for controlling charging a vehicle battery comprising:
determining, by a vehicle controller, a charging mode based on a comparison between a charging voltage of an external charger and a battery voltage;
transmitting, by the vehicle controller, a command of the charging mode to a battery controller;
selectively switching, by a switch box, an electrical connection between a first battery and a second battery and selectively switching, by the switch box, a connection of charging power to the first battery or the second battery, according to a control of the battery controller based on the command of the charging mode; and
supplying, by the vehicle controller, the charging power to the switch box according to the charging mode by controlling a charging circuit.

19. The method of claim 18, wherein the charging mode includes a separate charging mode for separately charging the first battery and the second battery and a connection charging mode for connecting and charging the first battery and the second battery.

20. The method of claim 19, wherein selectively switching includes disconnecting a series connection between the first battery and the second battery through a first switch and selectively connecting the charging power to the first battery or the second battery through a second switch and a third switch, in the separate charging mode.
